(19) United States
(12) Patent Application Publication
(10) Pub. No.: US 2010/0246676 A1
(43) Pub. Date: Sep. 30, 2010

(54) Method of downscale decoding MPEG-2 video

(75) Inventors: Jian-Gen Cao, Shanghai (CN); Cong-Xiu Wang, Shanghai (CN); Ping Xiao, Shanghai (CN); Chen Zhang, Shanghai (CN)

Correspondence Address: BACON & THOMAS, PLLC, 625 SLATERS LANE, FOURTH FLOOR, ALEXANDRIA, VA, 22314-1176, US

(73) Assignee: ArcSoft (Shanghai) Technology Co., Ltd., Shanghai (CN)

(21) Appl. No.: 12/591,858

(22) Filed: Dec. 3, 2009

(30) Foreign Application Priority Data
Mar. 24, 2009 (CN) 200910126891.4

(51) Int. Cl. H04N 7/48

(52) U.S. Cl. 375/240.13; 375/240.16; 375/E07.211

(57) ABSTRACT

A method of downscale decoding MPEG-2 video includes an Inverse Discrete Cosine Transformation (DCT) procedure for performing a ½ horizontal downscaling to convert DCT coefficients in a 8×8 array block of the video into a 4×8 array intra-block and performing a ½ vertical downscaling to convert the intra-block into an intra-coded picture having ¼ resolution of the original; and a downscaling motion compensation procedure for performing a motion compensation to the current intra-block to obtain a predictive block having ½ horizontal size of the original, adding the predictive block with a residual block produced by the same method applied to the intra-blocks to obtain a 4×8 array inter-block, and performing a ½ vertical downscaling to the inter-block for outputting a predictive-coded picture and a bidirectional predictive-coded picture having ¼ resolution of the original, so as to simplify the complexity of the decoding computation and enhance the decoding speed.

### FIELD OF THE INVENTION

The present invention relates to a video decoding method, and more particularly to a method of downscale decoding blocks of a MPEG-2 video while performing an inverse discrete cosine transformation (IDCT) and a motion compensation to the MPEG-2 video to achieve the effects of lightening data processing load, reducing the computation complexity, and enhancing the decoding speed effectively, so as to overcome an issue of a low efficiency of playing high-resolution video by a low-performance processor.

### BACKGROUND OF THE INVENTION

Since 1990, video compression technologies bloom and advance rapidly, and a video compression standard established by the ISO MPEG (Moving Picture Experts Groups) becomes a mainstream in this area. Until 1994, the ISO MPEG established the MPEG-2 standard that includes new compression technologies, and the MPEG-2 standard not just supports interlaced scanning only, but also breaks through traditional system reliability and video quality, and thus most of the present DVD video compression technologies and products available in the market adopt the MPEG-2 standard as the mainstream.

Compared with MPEG-2 encoders, MPEG-2 decoders have a less complicated decompression algorithm and require less computation and processing. These basic properties make the MPEG-2 decoders much easier to be implemented in hardware devices. With reference to FIG. 1, a MPEG-2 encoder generates MPEG-2 data streams including the following contents:
(1) A MPEG-2 data stream 10 is consisted of a plurality of groups of pictures GOP0, GOP1, GOP2, . . . GOPn.
(2) Each group of pictures GOP includes a series of pictures I, B, P.
(3) Each picture I, B, P falls into one of the following three types:
   (a) Intra-coded picture (I-picture): The I-picture is encoded according to the information provided by an original block, such that the I-picture can be randomly accessed from a sequence of a group of pictures.
   (b) Predictive-coded picture (P-picture): The P-picture is encoded by using a motion compensated prediction according to a past reference frame or a past reference field.
   (c) Bidirectional predictive-coded picture (B-picture): The B-picture is encoded by using a motion compensated prediction according to a past reference frame and/or a future reference frame.
(4) Each picture is divided into a plurality of slices.
(5) Each slice includes a number (greater than zero) of macroblocks (MB).
(6) Each macroblock includes different numbers of 8×8 array blocks of data 11.
   In a YUV (or YCbCr) color model, the blocks 11 are divided by their properties into the following three types:
   (a) Luminance (Y) block: It stands for the gray scale or gray intensity of a pixel in a picture, and includes four 8×8 array blocks 11;
   (b) Chrominance Blue (U, or Cb) block: It stands for the blue value of a pixel in a picture, and includes a 8×8 array block 11;
   (b) Chrominance Red (V, or Cr) block: It stands for the red value of a pixel in a picture and includes a 8×8 array block 11.

Each chrominance (Cr or Cb) has a number of blocks 11 varied with different YUV coding schemes.

With reference to FIG. 2 for a decompression algorithm of a MPEG-2 decoder, the algorithm comprises the following processing procedures:

(1) Variable Length Decoding (VLD) Procedure 20: This procedure decodes coded data in a MPEG-2 data stream according to the Huffman style coding, and converts values of each coded data into 64 vectors of a one-dimensional array.
(2) Inverse Scan (IS) Procedure 21: This procedure converts the 64 vectors outputted after going through the variable length decoding procedure 20 into a two-dimensional 8×8 array block for the use in future processing.
(3) Inverse Quantization (IQ) Procedure 22: A quantization is used for reducing the quantity of possible values, and an inverse quantization is to recover the code value to a value close to the original value. In other words, the code value of each of the blocks is recovered to an original value closest to the discrete cosine transformation (DCT) coefficient.
(4) Inverse Discrete Cosine Transformation (IDCT) Procedure 23: The procedure obtains an intra-block by converting the DCT coefficient into a block representing the 8×8 array YUV pixels in the picture, so as to generate and output the I-picture of the original block.
(5) Motion Compensation (MC) Procedure 24: This procedure uses all 8×8 array intra-blocks previously stored in a framestore memory as reference blocks to estimate the motion vectors of the pixels in the current 8×8 array intra-block to perform a motion compensation and obtain a predictive block and a residual block of the current intra-block, so as to calculate the 8×8 array inter-block, and further calculate the P-picture and the B-picture according to the 8×8 array inter-block and output the P-picture and B-picture of the original block.
(6) Framestore Memory Procedure 25: This procedure uses all previously obtained and saved 8×8 array intra-blocks to estimate the reference picture of the motion vectors of the pixels in the current 8×8 array intra-block.

In recent years, electronic technologies advance rapidly, and thus various different consumer electronic devices with a video playing function (such as mobile phones, personal digital assistants and video players) come with increasingly higher performance and lower price, and thus electronic devices have become indispensable video playing devices to our life and work, and users can download and play all kinds of video movies and programs by the electronic devices. Due to hardware design limitations, the computing speed of a processor and the storage capacity of a memory of the electronic devices cannot match up with a general personal computer, and thus users often encounter the following problems due to a slow computing speed of the processor and an insufficient storage capacity of the memory when the MPEG-2 video movies and programs are played by the electronic devices:
(1) Consuming more processing time: A traditional MPEG-2 video decoding method generally performs a complete decoding for a MPEG-2 data stream, and thus a low-performance processor cannot achieve an instant playback effect of playing MPEG-2 video movies and programs. In particular, this issue becomes more serious if high resolution video are played by an electronic device having a low-performance processor.
(2) Consuming additional downscaling time: If the display screen of the electronic device can input a video with a scale equal to ¼ of the original size of the video, then the traditional MPEG-2 decoding method generally decodes the original size of the video into YUV blocks before performing the downscaling. This arrangement consumes lots of decoding time and requires additional downscaling time, and thus causes a poor instant playback effect, and this situation becomes more seriously when high resolution video are played.
(3) Consuming more memory resources: Since the traditional MPEG-2 video decoding method decodes the whole MPEG-2 data stream, therefore huge data are generated and used in the decoding process, and a large quantity of memory resources is occupied, such that the situation of having insufficient memory space occurs very frequently, in particular when high resolution vides are played by an electronic device with a small memory capacity. As a result, the video cannot be played continuously, due to the insufficient memory space.

Therefore, it is an important subject for MPEG-2 video decoder designers and manufacturers to design a MPEG-2 video decoding method to overcome the aforementioned shortcomings, such as playing high resolution video by an electronic device with a slow computing speed, a small memory capacity and a small display screen, such that the invention can complete the decoding quickly and play video movies and programs on the display screen instantly to assure the performance of playing high resolution video by the electronic device and meet the basic user requirements.

### SUMMARY OF THE INVENTION

In view of the shortcomings of the prior art of which many electronic devices having a slow processing speed, an insufficient memory capacity and a small display screen are unable to play video movies and programs on the display screen by decoding the high resolution video by a MPEG-2 video decoding method instantly, the inventor of the present invention based on years of experience in the related industry to conduct extensive researches and experiments, and finally invented a method of downscale decoding MPEG-2 video in accordance with the present invention.

Therefore, it is a primary objective of the present invention to provide a method of downscale decoding MPEG-2 video, and the method is applied to an electronic device, and the electronic device can receive or read a MPEG-2 video to perform a downscaling process. The method performs a ½ horizontal downscaling IDCT to the DCT coefficients in a 8×8 array block of the video generated by an inverse quantization procedure to obtain a 4×8 array block, so as to convert the 8×8 array DCT coefficients in the block into 4×8 array YUV pixel values and obtain an intra-block with a horizontal size equal to ½ of the original block of the video. When the 4×8 array intra-block is outputted, a ½ vertical downscaling is performed to the pixel values of the 4×8 array intra-block to generate the intra-coded picture (I-picture) having a size equal to ½ of the horizontal size and ½ of the vertical size of the original block. In other words, the I-picture having a resolution equal to ¼ of the resolution of the original block is outputted.

Another objective of the present invention is to store all 4×8 array intra-blocks in a framestore memory as reference blocks when executing a motion compensation to the intra-block having a horizontal size equal ½ of the original block and generated in the downscaling IDCT procedure, so as to execute the motion compensation to motion vectors of pixel values of the 4×8 array intra-block to obtain a predictive block having a horizontal size equal ½ of the original block. Similarly, the same method of computing the intra-block is used for obtaining a residual block. The predictive block and the intra-block are added to produce a 4×8 array inter-block. When the 4×8 array inter-block is outputted, a ½ vertical downscaling is preformed to the 4×8 array inter-block, such that a predictive-coded picture (P-picture) and a bidirectional predictive-coded picture (B-picture) with ½ of the horizontal size and ½ of the vertical size of the original block are generated. In other words, the P-picture and B-picture with a resolution equal to ¼ of the resolution of the original block are outputted. This arrangement not only lightens the processing load of the picture data by several times, but also cuts down the data volume and required memory to one-half, and achieves the effects of simplifying the MPEG-2 video decoding computation complexity, the decoding speed, and overcoming the low efficiency of playing high resolution video by a low-performance processor.

### BRIEF DESCRIPTION OF THE DRAWINGS

FIG. 1 is a schematic diagram showing a structure of MPEG-2 data streams generated by a conventional MPEG-2 encoding method;

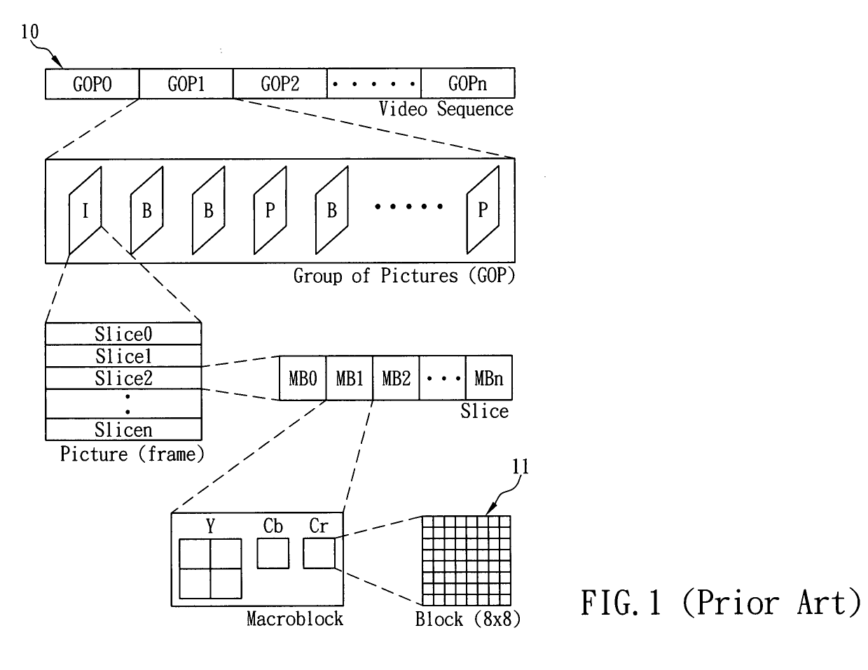

FIG. 2 is a flow chart of a conventional MPEG-2 decoding method;

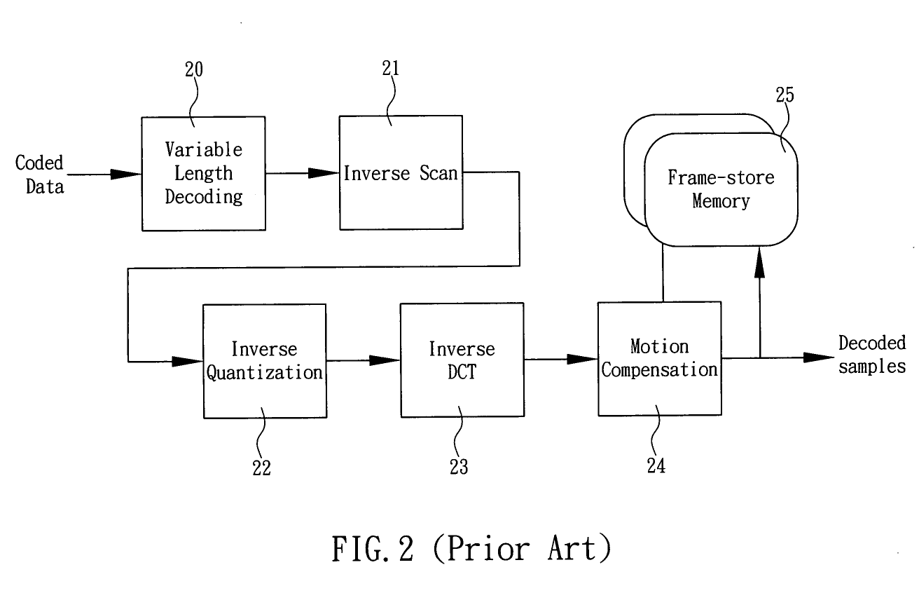

FIG. 3 is a flow chart of a MPEG-2 downscale decoding method in accordance with the present invention;

FIG. 4 is a flow chart of converting DCT coefficients into a block of 4×8 array YUV pixels in a picture during a downscaling IDCT process in accordance with the present invention;

FIG. 5 is a flow chart of performing a vertical ½ downscaling computation for pixels in a 4×8 array intra-block during a downscaling IDCT process in accordance with the present invention;

FIG. 6 is a flow chart of computing an inter-block during a downscaling motion compensation in accordance with the present invention; and

FIG. 7 is a flow chart of a downscaling motion compensation in accordance with the present invention.

### DETAILED DESCRIPTION OF THE PREFERRED EMBODIMENTS

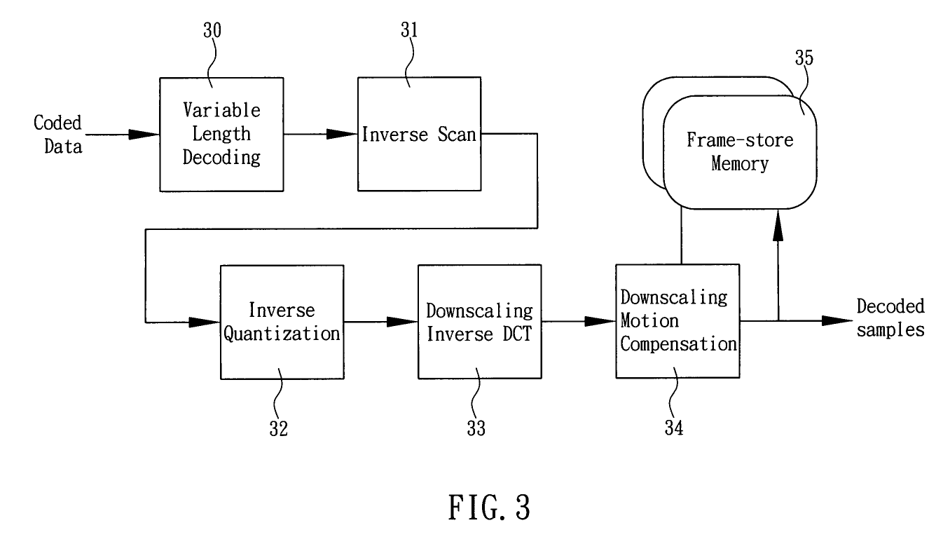

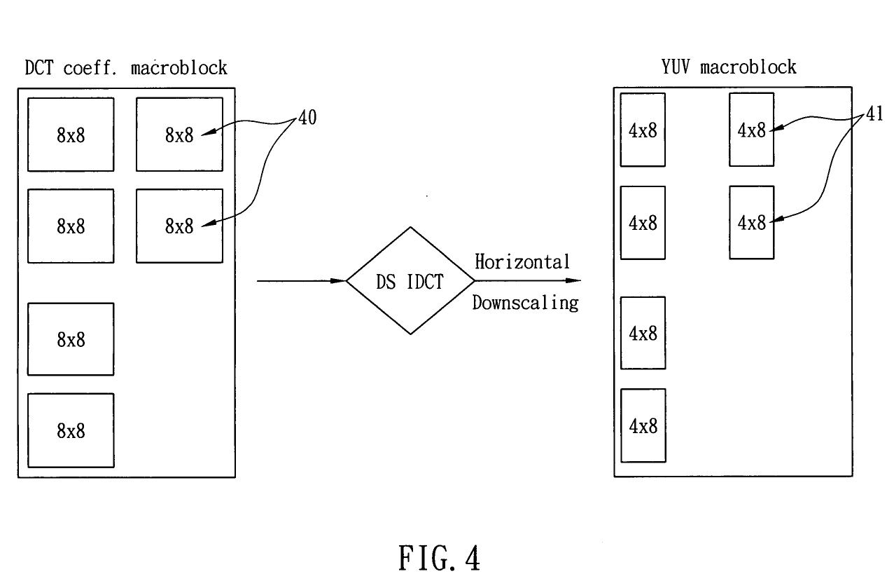

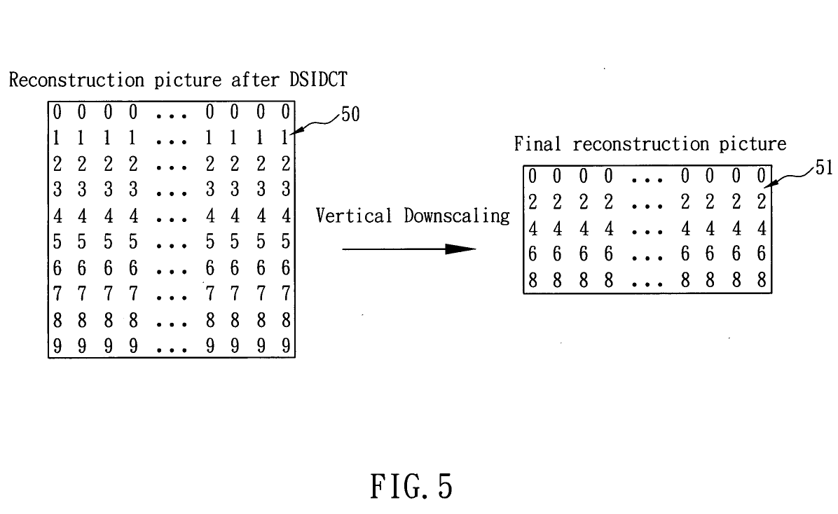

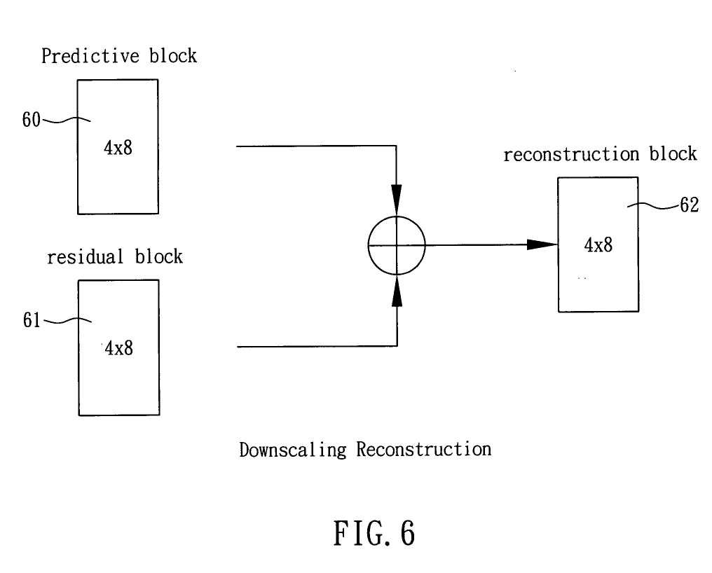

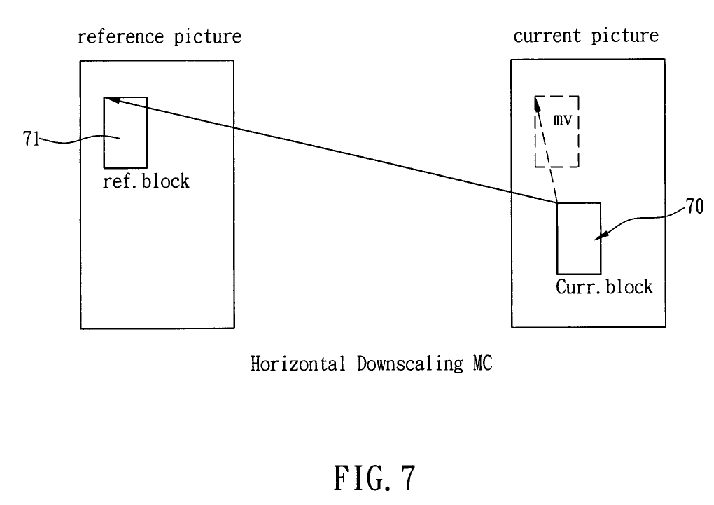

The present invention discloses a method of downscale decoding MPEG-2 video, and the method is applied to an electronic device, such that the electronic device can receive or read a MPEG-2 video stream to perform a downscale decoding to lighten the data processing load and reduce the required memory for decoding the video stream, so as to achieve the effects of simplifying the complexity of the MPEG-2 video decoding computation, improving the decoding speed, and overcoming the drawback of a low efficiency of playing high resolution video by a low-performance processor of the electronic device. As shown in FIG. 3, the method comprises the following procedures:
(1) Variable Length Decoding Procedure 30: The variable length decoding procedure 30, which is the same procedure used in a traditional MPEG-2 decoder, decodes a coded data of an image frame in the video stream according to the Huffman coding to convert each of the coded data into 64 vectors. Since the variable length decoding procedure 30 is a prior art and not a technical characteristic covered in the claims of the present invention, and thus will not be described in details here.
(2) Inverse Scan Procedure 31: The inverse scan procedure 31, which is the same procedure used in a traditional MPEG-2 decoder, converts the 64 vectors corresponding to each of the coded data into a 8×8 array block. Since the inverse scan procedure 31 is a prior art and not a technical characteristic to be covered in the claims of the present invention, and thus will not be described in details here.
(3) Inverse Quantization Procedure 32: The inverse quantization procedure 32, which is the same procedure used in a traditional MPEG-2 decoder, converts the value of each of the blocks into an original value close to the Discrete Cosine Transformation (DCT) coefficient. Since the inverse scan procedure 32 is a prior art and not a technical characteristic covered in the claims of the present invention, and thus will not be described in details here.
(4) Downscaling (DS) Inverse Discrete Cosine Transformation (IDCT) Procedure 33: All I-pictures included in the MPEG-2 video stream are composed of intra-blocks and each macroblock of the I-picture of the YUV4:2:0 coding scheme includes four 8×8 array luminance blocks representing a gray scale or gray intensity of a pixel in a picture, one 8×8 array chrominance blue block representing a blue value of the pixel in the picture, and one 8×8 array chrominance red block representing a red value of the pixel in the picture. The DS IDCT procedure 33 performs a traditional IDCT procedure to DCT coefficients of a 8×8 array block 40 generated by the inverse quantization procedure 32 and then performs a ½ downscaling to the result thererof. In FIG. 4, a 4×8 array block is obtained, and when a DS IDCT procedure 33 is performed to 8×8 array DCT coefficients in a block to convert the DCT coefficients into a block 41 of 4×8 array YUV pixels in the picture, so as to obtain an intra-block having a horizontal size equal to ½ of the horizontal size of the original block. When the 4×8 array intra-block is outputted, a ½ vertical downscaling is performed to the pixel values of the 4×8 array intra-block to obtain an intra-block 51 with a size equal to ½ of the horizontal size and ½ of the vertical size of the original intra-block 50 as shown in FIG. 5, and generate an intra-coded picture (I-picture) having a size equal to ½ of the horizontal size and ½ of the vertical size of the original block. In other words, an I-picture having a resolution equal to ¼ of the resolution of the original block is outputted.
(5) Downscaling Motion Compensation Procedure 34: The P-picture and B-picture contained in the MPEG-2 video stream include two modes: intra-block and inter-block, and both modes belong to a part of intra-blocks and these intra-blocks are decoded in the same way of decoding an I-picture as shown in FIGS. 4 and 5, and the part of the inter-blocks 62 is obtained by adding a residual block 61 and a predictive block 60 of the current intra-block together as shown in FIG. 6. In the present invention, a traditional IDCT procedure is performed to the 4×8 array DCT coefficients in the residual block 61 to convert the DCT coefficients back into the 4×8 array YUV pixels in the picture. As regards the predictive block 60, a motion estimation is performed to calculate the motion vectors of the current intra-block, and a linear interpolation is performed by using the motion vectors and all 4×8 array intra-blocks previously stored in a framestore memory as reference blocks to obtain the predictive block 60. In the MPEG-2 standard, the P-picture can have a forward reference picture, and the B-picture can have a forward reference picture and a backward reference picture, and thus the reference picture of the B-picture can only be an I-picture and/or a P-picture. Since the I-picture obtained in the DS IDCT procedure 33 is a ½ downscaling result of the original block, the present invention must adopt the corresponding downscaling motion compensation procedure 34 as shown in FIG. 7. In other words, the size (or resolution) of the current block 70 is determined by the size (or resolution) of the reference block 71. Meanwhile, a scale conversion computed by the following equations must be carried out according to the motion vector (mv) and the block size obtained from the video stream for computing the motion compensation:

mv′.x=(mv.x−sign(mv.x))>>1

mv′.y=mv.y

block′.x=block.x>>1=8>>1=4

block′.y=block.y=8
, such that, after going through a ½ horizontal downscaling, the block size of the inter-block and the motion vectors of the corresponding inter-block can be calculated, wherein mv.x and mv.y are motion vectors of the original inter-block; mv′.x and mv′.y are motion vectors of a downscaled block; block.x and block.y are block sizes of the inter-block; block′.x and block′.y are block sizes of the corresponding downscaled block, and sign(x) is an operator taking a value x for the data. Therefore, the downscaling motion compensation procedure 34 stores all 4×8 array intra-blocks in the framestore memory as reference blocks, and carries out a motion compensation with respect to the motion vectors of the pixel values of the current 4×8 array intra-block to obtain a predictive block 60 having a horizontal size equal to ½ of the horizontal size of the original block. The predictive block 60 is added to a residual block 61 to obtain the 4×8 array inter-block 62. When the inter-block 62 is outputted, a ½ vertical downscaling is carried out for the inter-block 62 to generate a P-picture and a B-picture having a size equal to ½ of the horizontal size and ½ of the vertical size of the original block. In other words, a P-picture and a B-picture can be outputted with a resolution equal to ¼ of the resolution of the original block.
(6) Framestore Memory Procedure 35: The procedure uses the framestore memory to store all of the previously generated 4×8 array blocks as reference blocks for estimating the motion vectors of the pixel values in the current 4×8 array inter-block.

When the present invention executes the IDCT procedure and the motion compensation procedure, the invention also processes the downscaling for the blocks, and thus the MPEG-2 decoder of the present invention has the following advantages over the traditional MPEG-2 decoder:
(1) Since the decoding process of the present invention adopts a DS IDCT and a DS motion compensation technology, the invention lightens the processing load of the picture data in several times when the coded data in the video stream are downscaled, and cuts down the data volume and the required memory to one-half. As to an electronic product with the same processing capability, the .downscale decoding method of the present invention can achieve the effects of simplifying the complexity of the MPEG-2 video decoding computation, improving the decoding speed and performance by more than 40%, and effectively overcoming the drawback of the traditional decoding method that cannot play high resolution video by a low-performance processor.
(2) Since the decoding process of the present invention executes the downscaling process simultaneously, therefore it is not necessary to execute additional downscaling for the YUV blocks of the decoded MPEG-2 data stream. If a video with a scale of approximately ¼ is inputted to the display screen of the electronic device, the decoded video movies and programs can be played immediately. Therefore, the invention can overcome the drawback of the traditional decoding method that cannot play high resolution video by a low-performance processor.
(3) In a time domain, the pictures outputted by the downscaling decoder of the present invention come with the same scaled picture data (row pictures or every-other-row pictures), and thus it is not necessary to execute a de-interlacing process for the picture data before the picture data are displayed on the display screen of the electronic device, and the picture data can be displayed directly on the LCD display screen, so as to achieve the effects of simplifying the complexity of the whole display system of the display screen of the electronic device and enhancing the system performance of the display screen effectively.

While the invention has been described by means of specific embodiments, numerous modifications and variations could be made thereto by those skilled in the art without departing from the scope and spirit of the invention set forth in the claims.

What is claimed is:

1. A method of downscale decoding a MPEG-2 video, which is applied to an electronic device capable of receiving or reading discrete cosine transformation (DCT) coefficients in a 8×8 array block of a MPEG-2 video stream to perform a downscaling, comprising:
an inverse discrete cosine transformation (IDCT) procedure, for performing a ½ horizontal downscaling IDCT to the discrete cosine transformation (DCT) coefficients in a 8×8 array block to obtain a 4×8 array block, so as to convert the discrete cosine transformation (DCT) coefficients in the 8×8 array block into 4×8 array YUV pixel values in a picture and obtain an intra-block having a horizontal size equal to ½ of the horizontal size of an original block, and performing a ½ vertical downscaling to the pixel values of the intra-block, when the intra-block is outputted, to generate an intra-coded picture having a resolution equal to ¼ of the resolution of an original block; and
a motion compensation procedure, performing a motion compensation to the motion vectors of the pixel values of the current 4×8 array intra-block, by reference to all 4×8 array intra-blocks previously stored in a framestore memory as reference blocks, to obtain a predictive block having ½ horizontal size of the original block, adding the predictive block with a residual block produced by the same method applied to the intra-blocks to obtain a 4×8 array inter-block, and performing a ½ vertical downscaling to the pixel values of the inter-block, when the inter-block is outputted, to output a predictive-coded picture and a bidirectional predictive-coded picture having a resolution equal to ¼ of the resolution of an original block.

2. The method of claim 1, wherein the predictive-coded picture and the bidirectional predictive-coded picture include an intra-block mode and an inter-block mode, and a part thereof belonging to the intra-block mode adopts a decoding method which is the same method for decoding the intra-coded picture, and the other part belonging to the inter-block mode is obtained by adding the residual block and the predictive block of the current intra-block, and the method further comprises:
performing a ½ horizontal downscaling IDCT procedure to the 8×8 array discrete cosine transformation (DCT) coefficients in the residual block to convert the discrete cosine transformation (DCT) coefficients into the 4×8 array YUV pixels in the picture; and
using the motion vectors of the current intra-block obtained from a motion estimation and all 4×8 array blocks previously stored in the framestore memory as reference blocks to perform a linear interpolation to obtain the predictive block.

3. The method of claim 2, wherein the procedure of calculating a motion compensation obtains a motion vector my and a block size from the video stream to perform a scale conversion according to the equations of:
mv′.x=(mv.x−sign(mv.x))>>1
mv′.y=mv.y
block′.x=block.x>>1=8>>1=4
block′.y=block.y=8
to calculate a block size of the inter-block after going through a ½ horizontal downscaling and a motion vector corresponding to the inter-block, wherein mv.x and mv.y are motion vectors of the original inter-block, and mv′.x and mv′.y are corresponding motion vectors after a downscaling is performed, and block.x and block.y are block sizes of the inter-blocks, and block′.x and block′.y are block sizes after a downscaling is performed, and sign(x) is a sign operator taking a value x as a data.

4. The method of claim 3, further comprising: a framestore memory procedure, and the framestore memory procedure storing all 4×8 array intra-blocks previously generated and stored in the framestore memory to estimate the reference blocks of the motion vectors of the pixel values in the current 4×8 array intra-block.

5. The method of claim 4, further comprising: an inverse quantization procedure, and the inverse quantization procedure being provided for converting the value of the 8×8 array block in the video stream back into an original value close to the discrete cosine transformation (DCT) coefficient.

6. The method of claim 5, further comprising: an inverse scan procedure, and the inverse scan procedure being provided for converting 64 vectors corresponding to the coded data in the video stream into the 8×8 array block.

7. The method of claim 6, further comprising: a variable length decoding procedure, and the variable length decoding procedure decoding a sequence of the coded data in the video stream according to the Huffman coding to convert each of the coded data into the 64 vectors.
